(19) United States
(12) Patent Application Publication
(10) Pub. No.: US 2023/0117049 A1
(43) Pub. Date: Apr. 20, 2023

(54) NOBLE METAL NANOPARTICLES FOR INTENSITY AND TIME-RESPONSE ENHANCEMENT OF LUMINESCENT DYES

(71) Applicant: University of Washington, Seattle, WA (US)

(72) Inventors: Dana Dabiri, Seattle, WA (US); Guozhong Cao, Seattle, WA (US); Wenwen Yin, Seattle, WA (US)

(73) Assignee: University of Washington, Seattle, WA (US)

(21) Appl. No.: 17/904,006

(22) PCT Filed: Feb. 11, 2021
(86) PCT No.: PCT/US2021/017677

§ 371 Date: Aug. 10, 2022

Related U.S. Application Data
(60) Provisional application No. 62/976,651, filed on Feb. 14, 2020.

(51) Int. Cl. C09K 11/87; G01N 21/64

(52) U.S. Cl. CPC C09K 11/87; G01N 21/648; G01N 2021/6432; B82Y 30/00

(57) ABSTRACT

A method for modulating the piasmonic resonance of a noble metal nanoparticle to enhance the luminescence of an oxygen sensitive dye; an oxygen sensitive composition that includes a nanostructure comprising a noble metal particle and an oxygen sensitive dye: a substrate having a surface coated with the oxygen sensitive composition; methods and sensors for determining oxygen concentration using the oxygen sensitive composition.

### CROSS-REFERENCE TO RELATED APPLICATION

This application claims the benefit of U.S. application Ser. No. 62/976,651, filed Feb. 14, 2020, expressly incorporated herein by reference in its entirety.

### STATEMENT OF GOVERNMENT LICENSE RIGHTS

This invention was made with government support under Grant No. W911NF-18-1-0143, awarded by the U.S. Array Research Office. The government has certain rights in the invention.

### BACKGROUND OF THE INVENTION

Oxygen is closely involved with almost all living organism and is therefore one of the most important chemical species on earth. In this regard, precise measurements of its concentration are thus crucial. In general, the oxygen sensors can be divided into three types based on different measurement mechanisms: pressure, electrochemistry and luminescence quenching. The most common systems for oxygen sensing are based on either electrochemical devices, such as the Clark electrode, or optical oxygen sensors. Electrodes, without the problem of environmental interferences by ion strengths, heavy metals, or media are reliable with long term stability. Clark electrodes operate on the basis of electrical current change in response to the O₂ reduction reaction. However, the disadvantage of Clark electrodes is that they consume O₂ during measurements and are limited to a point analysis of samples; they are also unable to map out the O₂ distribution as well as not being suitable for small volumes for single cell study. Luminescence-based oxygen sensors have undergone rapid growth and are in the process of replacing the Clark electrode as they are non-invasive, disposable, easily miniaturized and simple to process in many fields. Unlike electrode-based sensors, optical oxygen sensors are based on luminescence quenching through energy exchange, in which excited-state luminophores transfer energy to surrounding O₂ molecules and thereby preventing luminescence. There is no doubt that the application of luminescence-based detection is an important spectrum technology for measurement owing to its great versatility, simplicity, sensitivity and non-invasive measurement. However, the low quantum efficiency, photobleaching and auto-luminescence have greatly prevented luminescence-based and phosphorescence-based detection from achieving high sensitivity. In this respect, the use of dyes for oxygen measurement requires high luminescence intensity and photostability.

Pressure Sensitive Paint (PSP) based on oxygen quenching of luminescence from the paint also faced the same problems. In general, PSP is based on luminescence quenching of the dye by molecular oxygen and its mechanism can be explained as follows: under the exposure of light at an appropriate wavelength, the dye's electrons will be excited to an upper singlet energy state (e.g., excited luminophore) or triplet energy state and then recover to ground state, emitting photons at a longer wavelength. When an excited luminophore interacts with O₂, part of the excited state energy is transferred to a vibrational mode of O₂, a process called oxygen quenching. The quenching process competes with the radiation process and its rate is dependent on the partial pressure of oxygen.

Metal enhanced luminescence (MEL), enhancing emission intensity of dyes in the vicinity of metal nanostructures, has been studied for oxygen measurements. This augmentation of emission can he mainly attributed to the increased excitation rate due to a local field enhancement effect and the increased emission rate by surface plasmon coupled emission, which can increase both the quantum yield and dyes intensity. The local surface plasmon resonance (LSPR) coupled emission enhancement is a complicated process impacted by a variety of parameters, including sizes and morphologies of the metal and dyes nanoparticles, distance between the metal surface and the dye, and spectral overlap of the metal LSPR with the emission or/and excitation spectra of the dye. The emission intensity of the dye is strongly correlated with the degree of the spectral overlap with the plasmon resonance of the nanoparticle, while the plasmon resonance of nanoparticles is highly depending on the nanoparticle size and shape. In this regard, numerous noble metal structures have been considered in L:Ag nanospheres, nanowires, nanoclusters, nanorods, nanocubes; Au nanospheres, nanostars, nanocages, nanowires, Au nanomatryoshka; Cu arrays; and noble metal alloys.

Despite advances in the developments of plasmonic nanomaterials for luminescent enhancement, there is still lack of the application of MEL in luminescence-based oxygen detection. A need exists for improved methods for the use of noble metal materials in oxygen sensing devices and techniques. The present invention seeks to fulfill this need and provides further related advantages.

### SUMMARY OF THE INVENTION

In one aspect, the invention provides a method for modulating the plasmonic resonance of a noble metal nanoparticle to enhance the luminescence of an oxygen sensitive dye. In certain embodiments, the method comprises:

growing a pre-determined number of noble metal nanoparticles to a pre-determined size on a surface of a nanostructure to provide a nanostructure having a surface with a pre-determined density of noble metal nanoparticles of pre-determined size thereon,

wherein growing the noble metal nanoparticles comprises subjecting the surface with one or more noble metal particle forming reagents at a concentration and for a time sufficient to grow the nanoparticles to the pre-determined size, and

wherein the pre-determined density and the pre-determined size of the noble metal nanoparticles is adapted to maximize an overlap of the plasmonic resonance of the noble metal nanoparticles and the absorbance of an oxygen sensitive dye to enhance luminescence of the oxygen sensitive dye.

In another aspect, the invention provides an oxygen sensor composition. In certain embodiments, the oxygen sensor composition comprises:

(a) a nanostructure having noble metal nanoparticles on its surface, the nanoparticles having a plasmonic resonance in the range from about 400 to about 600 nm;

(b) an oxygen sensitive dye having an emission sensitive to oxygen concentration, the oxygen sensitive dye having an absorbance in the range from about 390 to about 550 nm, wherein the plasmonic resonance of nanoparticles overlaps with the absorbance of the oxygen sensitive dye; and

(c) an oxygen permeable matrix in which the nanostructure and oxygen sensitive dye are dispersed.

In a further aspect of the invention, coated substrate surfaces are provided. In certain embodiments, the substrate has a surface on which is deposited the oxygen sensitive composition described herein.

In another aspect, the invention provides methods for determining oxygen concentration on a surface of a substrate are provided. In certain embodiments, the method comprises:

(a) subjecting a substrate surface having disposed thereon an oxygen sensitive composition as described herein, to an atmosphere that includes oxygen; and

(b) measuring the luminescent emission from the surface to determine oxygen concentration on the surface.

In a further aspect, the invention provides a noble metal nanoparticle coated with a dielectric surface to provide a nanostructure, having plasmonic resonance properties. The nanostructure comprises a noble metal nanoparticle coated with a pre-determined thickness of a dielectric coating. These nanostructures can be used in oxygen sensitive compositions and for sensors and methods for determining oxygen concentration.

### DESCRIPTION OF THE DRAWINGS

The foregoing aspects and many of the attendant advantages of this invention will become more readily appreciated as the same become better understood by reference to the following detailed description, when taken in conjunction with the accompanying drawings.

FIGS. 1A-1C compares UV-Vis spectra of SiO₂@Ag synthesized through loading different amounts of THPC-Au seeds on SiO₂ nanospheres. In each figure, each line is the UV-Vis spectrum of SiO₂@Ag prepared by the reaction of SiO₂@Au with 0(S-0), 50(S-50), 100(S-100) and 200(S-200) μl 0.1 M AgNO₃. Specifically, in FIG. 1A, from bottom to top, the lines correspond to SiO₂@Ag prepared with 0.1 g SiO₂ loaded with 5 ml THPC-Au and reacted with 0 (1S-0), 50 (1S-50), 100 (1S-100) and 200 ul (1S-200) 0.1 M AgNO₃; in FIG. 1B, from bottom to top, the lines correspond to SiO₂@Ag prepared with 0.1 g SiO₂ loaded with 30 ml THPC-Au and reacted with 0 (2S-0), 50 (25-50), 100 (25-100) and 200 ul (2S-200) 0.1 M AgNO₃; and in FIG. 1C, from bottom to top, the lines correspond to SiO₂@Ag prepared with 0.1 g SiO₂ loaded with 120 ml THPC-Au and reacted with 0 (3S-0), 50 (3S-50), 100 (3S-100) and 200 ul (3S-200) 0.1 M AgNO₃.

FIGS. 2A-2D compare TEM images of SiO₂ (FIG. 2A), 1S-100 SiO₂@Ag (FIG. 2B), 2S-100 SiO₂@Ag (FIG. 2C) and 3S-100 SiO₂@Ag (FIG. 2D).

FIGS. 3A and 3B compare luminescence (phosphorescence) intensity (FIG. 3A) and Stern-Volmer plots (FIG. 3B) for PtTFPP-based oxygen sensor and PtTFPP & MEP (metal enhanced phosphorescence)-oxygen sensor mixed with different SiO₂@Ag nanoparticles as a function of oxygen concentrations (%).

FIG. 4A is a schematic illustration of the model considered in FDTD simulation. FIG. 4B is a simulated extinction profile of two AgNPs with different gap. FIG. 4C shows the near electromagnetic field of two AgNPs with different gap excited by 400 nm incident light.

FIGS. 5A-5E shows the UV-Vis Spectra of SiO₂@Au (FIG. 5A) and TEM images of SiO₂ (FIG. 5B), 1# SiO₂@Au (FIG. 5C), 2# SiO₂@Au (FIG. 5D) and 3# SiO₂@Au NPs (FIG. 5E).

FIGS. 6A and 6B compare phosphorescence intensity (FIG. 6A) and Stern-Volmer plots (I_{O}/I) (FIG. 6B) for PtTFPP-based oxygen sensor and PtTFPP-based oxygen sensor with SiO₂@Au as a function of oxygen concentration.

FIG. 7A-7D compare UV-Vis spectra of Ag nanospheres (FIG. 7A) and Ag@SiO₂(FIG. 7B-7D) nanospheres with different core sizes (35 nm, 58 nm, 95 nm) and different thickness (5 nm, 10 nm, 15 nm and 25 nm).

FIG. 8A compares relative phosphorescence intensity for a PtTFPP-based oxygen sensor with Ag or Ag@SiO₂ at air pressure and FIG. 8B shows the dependence of the phosphorescence enhancement factor of PtTFPP-NPs based oxygen sensors compared with PtTFPP-based oxygen sensor (Iₛₐₘₚₗₑ/I_{PtTFPP}) on the silica shell thickness at air pressure.

FIG. 9 is a schematic illustration for seeded growth of SiO₂@Ag with tunable plasmon resonances.

### DETAILED DESCRIPTION OF THE INVENTION

The present invention provides improved plasmonic nanomaterials for luminescent enhancement, methods for preparing these nanomaterials, and methods for using these nanomaterials for enhancing luminescence in oxygen sensing devices and techniques.

In one aspect, the invention provides a method for modulating the plasmonic resonance of a noble metal nanoparticle to enhance the luminescence of an oxygen sensitive dye. In certain embodiments, the method comprises:

growing a pre-determined number of noble metal nanoparticles to a pre-determined size on a surface of a nanostructure to provide a nanostructure having a surface with a pre-determined density of noble metal nanoparticles of pre-determined size thereon,

wherein growing the noble metal nanoparticles comprises subjecting the surface with one or more noble metal particle forming reagents at a concentration and for a time sufficient to grow the nanoparticles to the pre-determined size, and

wherein the pre-determined density and the pre-determined size of the noble metal nanoparticles is adapted to maximize an overlap of the plasmonic resonance of the noble metal nanoparticles and the absorbance of an oxygen sensitive dye to enhance luminescence of the oxygen sensitive dye.

As used herein, the terms “luminescence” and “luminescent emission” refer to light emission from an oxygen sensitive dye and refer to both phosphorescence (phosphorescent emission) and fluorescence (fluorescent emission). The terms “luminescence” and “luminescent emission” are used interchangeably. Unless otherwise specified, as used herein, the term “emission” refers to luminescent emission.

In the operation of the method, the noble metal nanoparticle size and density size on the surface of the nanostructure is tuned to maximize an overlap of the plasmonic resonance of the noble metal nanoparticles and the absorbance of an oxygen sensitive dye to enhance luminescence of the oxygen sensitive dye. It will be appreciated that the plasmonic resonance of the noble metal nanoparticles on the surface of the nanostructure is the plasmonic resonance of the nanostructure (due to the nanoparticles on the nanostructure surface).

The pre-determined number of noble metal nanoparticles on the surface correlates to the number of noble metal seeds deposited on the nanostructure surface.

The pre-determined density of noble metal nanoparticles on the nanostructure surface is determined by the number of seeds deposited on the surface and the size of the nanoparticles grown on the surface. The number of seeds is readily controlled and the size of the nanoparticles is controlled by reaction conditions (e.g., concentration and reaction time for nanoparticle growth). The density (and ultimately plasmonic resonance) is varied depending on the nature of the oxygen sensitive dye: the density is tuned to maximize the overlap of the plasmonic resonance with the absorbance (excitation) spectrum of the oxygen sensitive dye.

In certain embodiments, the pre-determined size (diameter) of the noble metal nanoparticle is from about 5 to about 100 nm. For example, the Ag or Au nanoparticle size on an SiO₂ nanosphere 5-25 nm, and for Ag nanospheres (e.g., Ag@SiO₂) the nanoparticle size is 35-98 nm. Representative noble metal seeds include those known in the art, including THPC-Au seeds.

The size and shape of the nanostructure on which the nanoparticles are grown is not critical. Suitable nanostructures include nanospheres, nanowires, nanoclusters, nanorods, nanocubes, nanostars, and nanocages. The nanostructure is prepared from an electrical insulating material (i.e., a dielectric) and is electrical insulating. In certain embodiments, the nanostructure is a nanosphere. Representative nanospheres include silicon dioxide nanospheres, Other suitable nanosphere's include titanium dioxide nanospheres and RF resorcinol-formaldehyde) nanospheres.

In certain embodiments, the noble metal nanoparticle is a silver, gold, palladium, or platinum nanoparticle. Noble metal nanoparticles comprising mixtures of noble metals (e.g., alloys) are also useful in the methods and compositions of the invention.

Representative noble metal nanoparticles include silver and gold nanoparticles, which have advantageous plasmonic resonance properties. Alloys of silver and gold can also be used. The noble metal nanoparticles are prepared on the surface using noble metal particle forming reagents, which are noble metals salts suitable for reduction to provide noble metal nanoparticles. Representative noble metals salts include HAuClO₄ and AgNO₃. In the method, the time sufficient to grow the nanoparticles to the pre-determined size is from about 5 to about 10 minutes.

In the method of the invention, the plasmonic resonance (emission) is matched with the absorbance spectrum of an oxygen sensitive dye. In certain embodiments of the method, the plasmonic resonance is from about 400 to about 600 nm. In certain embodiments of the method, the absorbance spectrum of the oxygen sensitive dye includes absorbances in the range from about 400 to about 550 nm. In certain embodiments of the method, the overlap between the plasmonic resonance and the absorbance spectrum of the oxygen sensitive dye is from about 390 to about 550 nm.

The oxygen sensitive dye useful in the method is a dye whose emission is sensitive (e.g., quenched or diminished) to oxygen (O₂) concentration. The greater the oxygen concentration the greater the degree of emission quenching. Suitable oxygen sensitive dyes include those having an absorbance (excitation) spectrum that overlaps (i.e. has a spectral overlap) with the plasmonic resonance. Suitable oxygen sensitive dyes include metalloporphyrins and related derivatives. Representative metalloporphyrins include platinum metalloporphyrins and relative derivatives. In certain embodiments, the oxygen sensitive dye is platinum tetra(pentafluorophyenypporphine (i.e., PtTFPP). In other embodiments, the oxygen sensitive dye is platinum octaethylporphine (i.e., PtOEP).

In another aspect, the invention provides an oxygen sensor composition. In certain embodiments, the oxygen sensor composition, comprises:

(a) a nanostructure having noble metal nanoparticles on its surface, the nanoparticles having a plasmonic resonance in the range from about 400 to about 600 nm;

(b) an oxygen sensitive dye having an emission sensitive to oxygen concentration, the oxygen sensitive dye having an absorbance in the range from about 390 to about 550 nm, wherein the plasmonic resonance of nanoparticles overlaps with the absorbance of the oxygen sensitive dye; and

(c) an oxygen permeable matrix in which the nanostructure and oxygen sensitive dye are dispersed.

Suitable and representative nanostructures, noble metal nanoparticles particles, and oxygen sensitive dyes include those described above. In certain embodiments, the oxygen permeable matrix is a sol-gel matrix. Representative sol-gel matrices include xerogels.

In a further aspect of the invention, coated substrate surfaces are provided. In certain embodiments, the substrate has a surface on which is deposited the oxygen sensitive composition described herein. Suitable surfaces include metal, plastic, ceramic, glass, and cellulose surfaces. In certain embodiments, the oxygen sensitive composition is cast onto the substrate surface.

In another aspect of the invention, methods for determining oxygen pressure on a surface of a substrate are provided. In certain embodiments, the method comprises:

(a) subjecting a substrate surface having disposed thereon an oxygen sensitive composition as described herein, to an atmosphere that includes oxygen; and

(b) measuring the luminescent emission from the surface to determine oxygen concentration (or oxygen pressure) on the surface.

In certain embodiments of the method, subjecting the substrate surface to an atmosphere that includes oxygen comprises flowing the atmosphere over the surface.

The following describes representative plasmonic nanomaterials for luminescent enhancement (e.g., phosphorescence enhancement), representative methods for making these nanomaterials, and representative methods for using these nanomaterials for enhancing luminescence (e.g., phosphorescence) in oxygen sensing devices and techniques.

In one aspect, the present disclosure provides an improvement with regard to metal enhanced luminescence (MEL), including fluorescence (MEF)/metal enhanced phosphorescence (MEP), in optical oxygen sensors. Various noble metals, including Ag, Au, Cu, and metal alloys, can be employed to enhance the emission intensity of dyes useful for the determination of molecule oxygen, such as in a pressure sensitive paint (PSP). Through chemical synthesis, the invention provides noble metal nanoparticles having different shapes and compositions.

Utilizing plasmonic coupling to tune absorption bandwidth and boost electron oscillations in metal enhanced luminescence (MEL) has not been widely explored to date. The magnitude of the plasmonic coupling depends on the interparticle distance. When the two plasmonic nanoparticles come closer, their resonance modes start to hybridize, causing a red shift and broader resonance band that provides for the methods of the invention to tune the nanoparticle's absorbance peak in a wide spectral range and thus maximize the overlap of the nanoparticle's local surface plasmon resonance (LSPR) with the excitation (absorbance) spectrum of a luminescence dye with emission enhancement.

In one embodiment of the method of the invention, a seeded growth method is used to prepare SiO₂@Ag. As used herein, SiO₂@Ag refers to a silicon dioxide nanosphere having silver nanoparticles on its surface in which the silver nanoparticles are formed on the nanosphere surface by a seeded growth method. Representative seeded growth methods useful in the practice of the present invention include Y. Xia, K. D. Gilroy, H. C. Peng, X. Xia, Angew. Chem., Int Ed. 2017, 56, 60; C. Zhu, J. Zeng, J. Tao, M. C. Johnson, I. Schmidt-Krey, L. Blubaugh, Y. Zhu, Z. Gu, Y. Xia, J. Am. Chem. Soc. 2012, 134, 15822. It will be appreciated that SiO₂@Ag is a representative particle and that other noble metals (e.g., Au) can be used so long as they can be prepared on a surface by a seeded growth method.

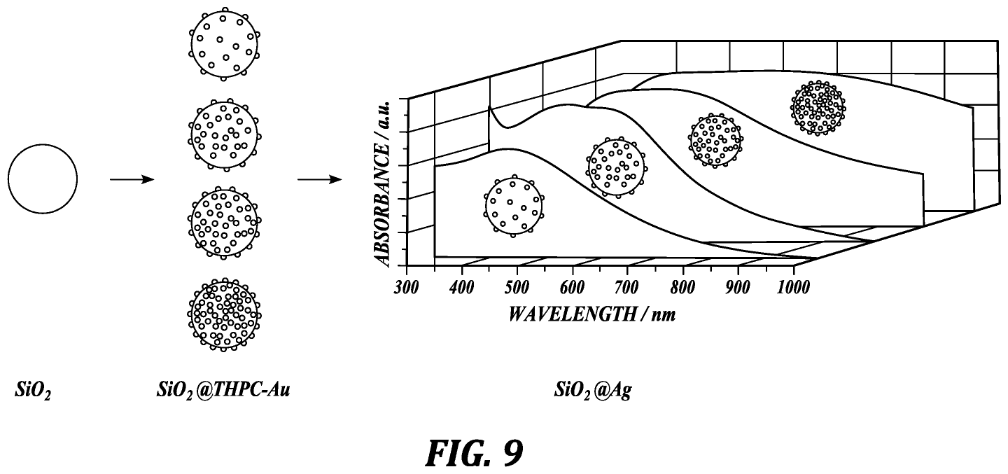

To tune the plasmonic resonance, seeds (e.g., THPC-Au seeds) are deposited on a nanosurface, such as a SiO₂ nanosphere, to provide particles with a seeded nanosurface having a pre-determined seed load, and then subjecting the particles to a seeded growth procedure to provide noble metal nanoparticles on each nanosurface (see FIG. 9). Particle samples are prepared by depositing different amounts of seeds to the surface of each group of particles. The subsequent growth of the noble metal nanoparticles from the seeds on the surface of the nanostructure not only gradually decreases the interparticle separation between the noble metal nanoparticles on the surface but also enhances the plasmonic coupling, leading to the formation of noble metal (e.g., Ag) nanoparticles with large absorption cross-sections that maximize the absorption of incident visible and near-IR light.

The tunable plasmonic resonance of the particle samples can be advantageously exploited in oxygen-sensing compositions and methods. For example, in one application, the tunable plasmonic resonance of the particles described herein can be used to optimize the sensitivity of pressure sensitive paints by enhancing the paints' luminescence intensity to provide metal enhanced luminescence-pressure sensitive paint (MEF-PSP).

In a representative PSP demonstration, platinum tetra(pentafluorophyenyl)porphine (PtTFPP), a commercial dye that has excellent photostability and good quantum yields, was dispersed in an organically-modified silicate matrix (i.e., sol-gel matrix) prepared as described in Example 3, which is an preferred matrix material for oxygen sensing applications due to its highly permeable to oxygen and favorable mechanical properties and higher sensitivities to oxygen than other matrices/binders (see, e.g., T. S. Yeh, C. S. Chu, Y. L. Lo, Sensors and Actuators B, 2006, 119, 701; C. S. Chu, Y. L. Lo, T. W. Sung, Talanta, 2010, 82, 1044.

Methods for Preparing SiO₂@Ag Nanospheres

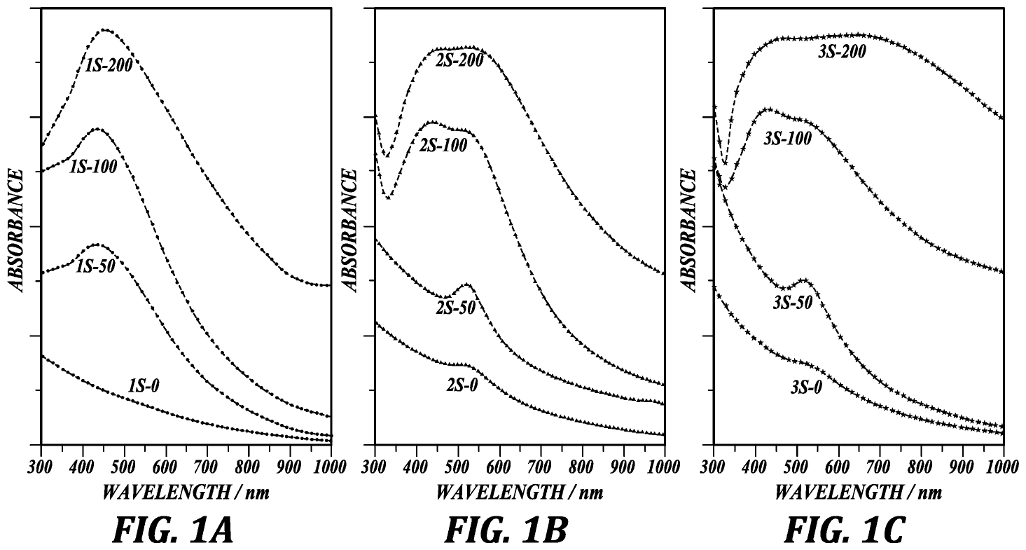

Seeded growth methods were used to prepare silicon dioxide nanospheres having silver nanoparticles on their surface (i.e., SiO₂@Ag nanospheres). To facilitate the growth of continuous and uniform Ag nanoparticles on the silica surface, SiO₂ nanoparticles are first modified with polyethyleneimine (PEI) and then attached with THPC-Au seeds for the seeded growth of Ag nanoparticles. In order to precisely tuning the plasmonic peak of SiO₂@Ag nanoparticles, the PEI modified SiO₂ (0.1 g) was mixed with different amounts of THPC-Au (5 ml, 30 ml, 120 ml). As shown in FIGS. 1A-1C, a small peak (0# SiO₂@Au) around 530 nm appeared and increased with increasing amount of Au seeds, which was attributed to the coupling or aggregating of large quantity of Au seeds. Once the reduction of Ag⁺ was initiated, the absorbance peak due to Ag appeared and became boarder as the volume of silver nitride solution increased. The seeded growth gradually increased the Ag particles size and shortened the Ag interparticle distance, enhancing the plasmonic coupling, finally leading to the wide absorption of incident visible light. With fewer Au seeds attached to the silica surface, the absorbance peak of SiO₂@Ag (FIG. 1A) localized at 450 nm; as the amount of AgNO₃ increased, the absorbance increased while still centered. at 450 nm. The main reason for this was that there were so few Au seeds on the silica surface that the interparticle distance was too far to couple with each other. Therefore, the resulting absorbance peak corresponds to absorbance of separated Ag nanoparticles on the SiO₂ surface. With more Au seeds loaded onto the silica surface, another peak at 530 nm appeared, as illustrated by in FIG. 1B, which corresponds to the absorbance of Au; adding more AgNO₃, the peak of Ag at 450 nm appeared and increased. Sample 2# has a strong absorbance between 400 nm and 600 nm. Mixing with 120 ml Au, the SiO₂@Ag nanospheres (FIG. 1C) exhibited a wide absorption spectrum in the visible light, indicating that Ag nanoparticles on the surfaces of silica nanospheres created hot-spot structures on the SiO₂@Ag nanospheres. The diversity in the size of Ag particles and strong coupling of Ag particles on the silica surface produce the continuous spectrum of resonant multimode. As can he seen in FIGS. 1A-1C, through varying the loading amount of Au seeds and the volume of silver nitride solution, the size and interparticle distance of silver nanoparticles on the surface of SiO₂ can be tuned; the plasmonic coupling of silver nanoparticles can be controlled. By this method, SiO₂@Ag nanospheres with different absorbance peak in the visible spectrum can be prepared.

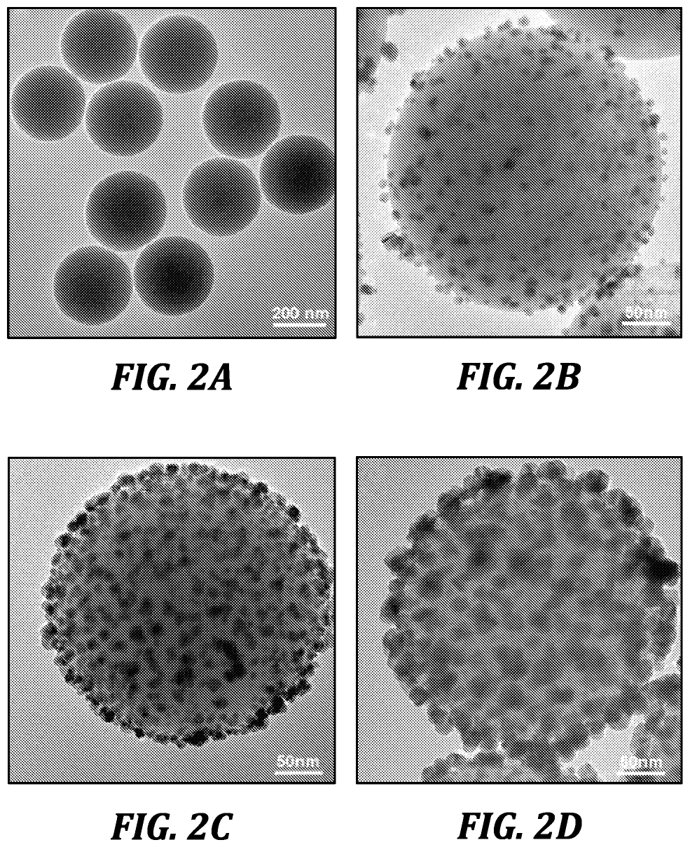

In one embodiment, the diameter of SiO₂ nanospheres prepared was about 300 nm (FIG. 2A). After attaching 5 ml Au seeds on the surface and seeded growth there are few small Ag particles (about 10 nm) on the surface, as shown in FIG. 2B. For this sample, there is a great distance for Ag plasmonic coupling, which is well matched with the UV-Vis absorbance of separated Ag nanoparticles, With the increment of loading amount of Au seeds and volume of AgNO₃, as shown in FIGS. 2C and 2D, the size of the Ag particles from the FIG. 2C and FIG. 2D is about 10 nm and 25 nm, respectively. It can be clearly seen that the density and size of Ag nanoparticles increased with increasing amount of Au seeds and AgNO₃, while, the gap between Ag nanoparticles on the surface of SiO₂@Ag nanospheres decreased. As illustrated in FIGS. 2B-2D, the number and size of the Ag nanoparticles can be varied by this method. The SiO₂ nanosphere can be sparsely coated with small Ag nanoparticles (FIG. 2B), or uniform and densely coated Ag nanoparticles (FIG. 2D).

SiO₂@Ag Nanospheres and Oxygen Sensitive Luminescent Dyes

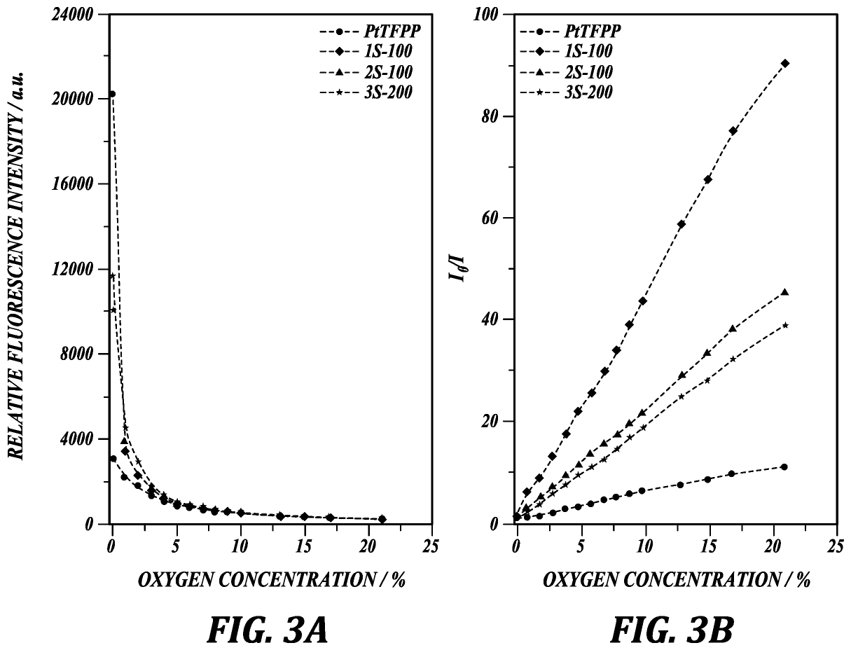

The absorption spectrum of the PtTFPP, a representative oxygen sensitive luminescent dye, has an absorbance band at 392 nm (Soret) and two absorbance bands at 508 nm and 541 nm (Q bands), respectively. Based on the theory that the intensity of emission intensity is highly dependent on spectral overlap of the metal LSPR with the absorbance and/or excitation spectrum of the dye, MEL of 1S-100 SiO₂@Ag, 2S-100 SiO₂@Ag and 3S-100 SiO₂@Ag PtTFPP-based PSP samples with different absorbance peaks were compared and tested. The samples of 1S-100 SiO₂@Ag, 2S-100 SiO₂@Ag and 3S-100 SiO₂@Ag are the SiO₂@Ag prepared by attaching 0.1 g SiO₂ with of 5 ml, 30 ml and 120 ml THPC-Au and then reacted with 100 ul 0.1M AgNO₃, separately. The spectra data in FIG. 3A illustrates that the relative emission intensities of oxygen sensors decrease as the oxygen concentration increases. In addition, at 21% O₂, the phosphorescence intensities of PtTFPP-based oxygen sensors and PtTFPP-based oxygen sensors with 1S-100 sample are almost same while at 0.05% O₂, they are 3000 and 21000, respectively; the O₂-quenching sensitivity of the oxygen sensor with 1S-100 sample is 7-fold higher than that of the PtTFPP-based oxygen sensors. For the other 2S-100, and 3S-200 based oxygen sensors, at 21% O₂, the phosphorescence intensities profiles are also almost the same as that of PtTFPP-based oxygen sensors with 1S-100. When the oxygen concentration reduced to 0.05%, the intensity of 2S-100, and 3S-200 based oxygen sensors is 11800 and 10500. The corresponding sensitivities are 3.9 and 3.5-fold higher than that of the PtTFPP-based oxygen sensors, respectively. When the concentration of O₂ is less than 5%, the intensities of PtTFPP-SiO₂@Ag based oxygen sensors are much higher than that of PtTFPP-based, oxygen sensors. The PtTFPP-based MEF-PSP samples have a good sensitivity at a low concentration of oxygen, which can be utilized to measure the variation of oxygen at extreme low concentration of oxygen. As shown for the SiO₂@Ag samples, the 1S-100 SiO₂@Ag mixed with PtTFPP dyes in sol-gel matrix exhibits highest sensitivity for the oxygen sensing. FIG. 3B shows the Stern-Volmer plots for PtTFPP-based oxygen sensors with and without SiO₂@Ag nanoparticles (in this work, I_{O} is the intensity of sensors at 0.05% oxygen concentration). The slope of the PtTFPP-based oxygen sensor is K_{SV}=0.56 (0.05%-21% oxygen concentration). The slopes of the Stern-Volmer plots for the PtTFPP-based oxygen sensors with 1S-100, 2S-100 and 3S-200 are 4.3, 2.2 and 1.8, respectively. It can also be seen that among these different SiO₂@Ag samples, the 1S-100 mixed with PtTFPP dyes in sol gel matrix exhibits the highest sensitivity for the oxygen sensing.

As mentioned above, the main absorbance of PtTFPP is centered at 392 nm. Compared with the UV-Vis spectra of these SiO₂@Ag nanosphere samples, the 1S-100 sample has the maximum overlap, resulting in the highest sensitivity. These data demonstrate that the phosphorescence intensity of dyes absorbed by the SiO₂@Ag nanospheres strongly relies on the overlap between the LSPR of the nanoparticle with spectra properties of the dye. As previous reported, when the absorbance spectra of noble metals overlap the emission spectra of dyes, the light emitted by the dyes can be also re-absorbed by the noble metal, which is called the inner filter effect. Those results proved that the inner filter effect definitely led to the decrease the phosphorescence density. Considering the inner filter effect, the less overlap between the LSPR of 1S-100 SiO₂@Ag and the emission spectra of PtTFPP is another key to the highest sensitivity. The results further confirm that the emission intensity and sensitivity of pressure sensor are highly dependent on the overlap between the LSPR of nanoparticles and the absorbance and spectra of dyes.

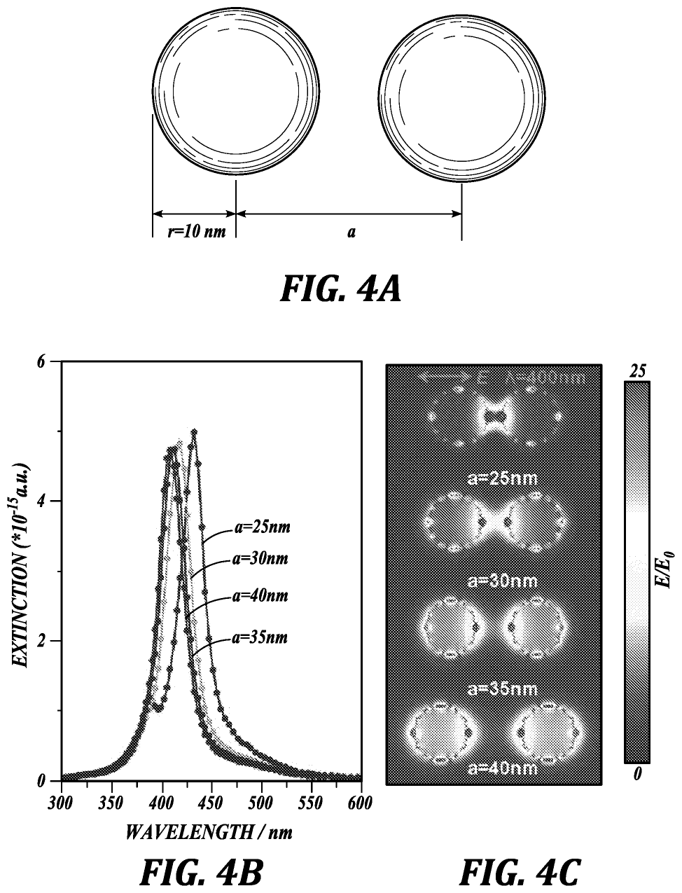

The results also indicate that the 1S-100 SiO₂@Ag sample with smaller AgNPs and larger interparticle distance exhibits the best performance in PtTFPP-based MEF-PSP. To further illustrate the plasmonic coupling's influence in MEL, two Ag nanoparticles were used in a simplified model to simulate the coupling via different interparticle distance through Finite-Difference Time-Domain Method (FDTD) solution. As schematically shown in FIG. 4A, the diameter of Ag nanoparticles and interparticle distance are set at 20 and 25-40 nm, respectively. FIG. 4B shows the extinction spectra of the two Ag nanoparticles as a function of interparticle distance. When the interparticle distance is set at 40 nm, the extinction spectrum of Ag nanoparticles exhibit a sharp peak at about 400 nm; the extinction spectra red-shifts once the interparticle distance decreased; when the interparticle distance is 25 nm, the extinction peak of Ag nanoparticles red-shifts to around 430 nm. These data indicate that as the interparticle gap decreases, the plasmonic coupling becomes stronger and the plasmonic peak red shifts. The interparticle plasmonic coupling can also be visualized in the FDTD solution by using a two-dimensional frequency-domain field profile. As shown in FIG. 4C, when incident light with wavelength of 400 nm irradiates the Ag nanoparticles along the X-axis, the near electromagnetic field shows great enhancement at the 25 nm gap; while at the 40 nm gap, there is no coupling. These data indicate that the plasmonic coupling can enhance the electromagnetic field and shift the peak away from 400 nm. Given that the laser beam for the luminescent test illuminates the samples at 400 nm, the plasmonic coupling leads to the peak shift far from the excitation laser's wavelength, also the maximum absorption peak of PtTFPP dyes, thereby resulting in less enhancement of luminescence. Therefore, the sample with a maximum absorption around 400 nm will exhibit the greatest enhancement of luminescence, which is consistence with the experiment data described herein.

MEL-Based Oxygen Sensors

SiO₂@Ag nanospheres with tunable optical properties through seeded-growth method were prepared and investigated in their application in PtTFPP-based PSP. The maximum overlap between the dyes and noble metal leads to highest luminescence enhancement and sensitivity in PtTFPP-based PSP. As described herein, the PtTFPP-based PSP with SiO₂@Ag nanospheres has good sensitivity at a low concentration of oxygen and the O₂-quenching sensitivity (I_{O}/I₁ₐₜₘ) of PtTFPP-based PSP with SiO₂@Ag nanospheres is 7.7-fold higher than that of the PtTFPP-based PSP. Combining the MEL with PSP provides improved sensitivity of PSP.

MEL-based oxygen sensors were prepared and evaluated based on SiO₂@Ag nanospheres, SiO₂@Au nanospheres, Ag@SiO₂ nanospheres, as described below.

Methods for Preparing SiO₂@Au Nanospheres

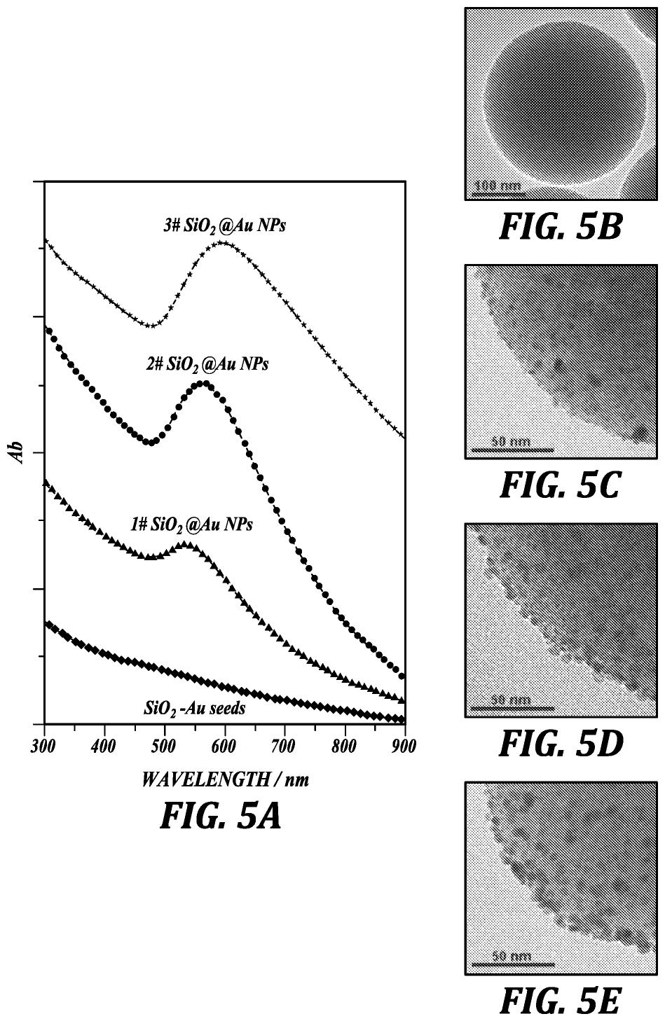

In a typical synthesis, the seeded growth method is most commonly used to synthesize SiO₂@Au NPs, which involves two steps: deposition of nucleus seeds on the functionalized SiO₂ surface and Au nanoparticle growth. The synthesis procedure principle of monodisperse SiO₂@Au NPs is as follows: SiO₂ with 300 nm diameter NPs were first prepared by using a modified Stoker method as the core. 0.6 g SiO₂ NPs were ultrasonically treated with 60 ml PEI (polyethyleneimine, 1% wt) solution to form PEI-coated SiO₂ NPs for 1 h. The positively charged PEI effectively attached to the negatively charged SiO₂ NPs and formed a stable polymer layer via electrostatic self-assembly. SiO₂@Au-seeds were prepared by adsorbing Au NPs (10 ml; about 2 nm) on the PEI layer of SiO₂ (0.1 g) NPs through covalent binding between the —NH₂ groups of PEI and Au nanoparticles, as stated in the literature. Finally, SiO₂@Au NPs were quickly obtained through reduction of plating solution by formaldehyde (0.05 ml, 37%) wider the stabilization of sodium citrate (0.2 ml, 0.1M). The plating solution was firstly prepared by adding 7.5 ml of 25 mM HAuCl₄ in 500 ml of 1.8 mM K₂CO₃ aqueous solution and stored for a minimum of 24 h before use. The uniform Au nanoparticles outside the SiO₂ NPs were formed within 5 minutes through the isotropic growth of all Au seeds under sonication. In order to obtain SiO₂@Au NPs with controllable plasmonic peak in a wide range, the plating solution was varied from 20 ml (1# SiO₂@Au), 60 ml (2# SiO₂@Au) to 100 ml (3#SiO₂@Au). FIG. 5A illustrates the UV-Vis spectra of the as-prepared products with different volume of growth solution dispersed in DI water. As shown in FIG. 5A, there is no peak of SiO₂—Au seed without HAuClO₄ growth solution. After injection of 20 ml growth solution and reduction reagent of 0.05 ml formaldehyde (37%) into the 1 ml SiO₂@Au seeds (0.1 mg/ml) suspension, the reduction of Au³⁺ was initiated. The absorbance peak located at 530 nm (1# SiO₂@Au NPs) appears indicates the formation of Au nanoparticles on the SiO₂ surface. As the volume of the growth solution increases to 60(2# SiO₂@Au NPs) and 100 ml (3# SiO₂@Au NPs), the absorbance peaks obviously red-shifted to 600 nm and the intensity increased significantly. The main reason for the different plasmonic peak of SiO₂@Au samples prepared with different amount of growth solution was that as the growth solution increases, the size of Au nanoparticles increases; the interparticle distance was shortened, thereby enhancing the plasmonic coupling. Both the increase size of Au nanoparticles and the plasmonic coupling lead to the red-shift and broad absorption of incident visible lights. As described herein, the SiO₂ nanospheres prepared were 300 nm (FIG. 5B). For the SiO₂@Au nanospheres prepared with the growth solution increases from 20 ml to 100 ml in FIGS. 5C-5E, the size of Au nanoparticles on the SiO₂ surface is 8 nm (1# SiO₂@Au), 10 nm (2# SiO₂@Au), and 12 nm (3# SiO₂@Au), separately. The amount of Au nanoparticles on SiO₂ nanospheres also increase. Thus, the nanogap between Au nanoparticles on the surface of SiO₂ nanospheres decreased. Through this method, the SiO₂ can be sparsely coated with small Au nanoparticles (FIG. 5C), or uniform and densely coated Au nanoparticles (FIG. 5E).

SiO₂@Au Nanospheres and Oxygen Sensitive Luminescent Dyes

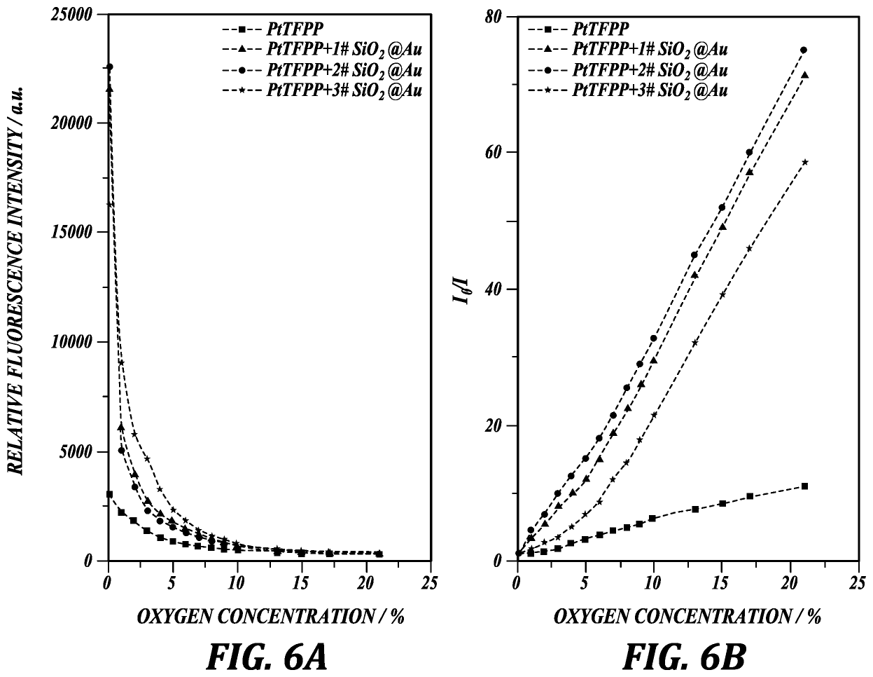

The performance of PtTFPP-based oxygen sensors mixed with 1# SiO₂@Au, 2# SiO₂@Au, and 3# SiO₂@Au (SiO₂@Au are prepared by attaching 0.1 g SiO₂ with 10 ml THPC-Au seeds and then added 20 ml (1#), 60 ml (2#) to 100 ml (3#) HAuClO₄-growth solution) were compared and tested. The performance of PtTFPP-based oxygen sensors was also compared and tested. FIG. 6A shows that the relative luminescence intensities of the oxygen sensors decrease as the oxygen concentration increases. In addition, the luminescence intensities of SiO₂@Au-PtTFPP-based oxygen sensors are higher than that of PtTFPP-based oxygen sensors at the same concentrations of oxygen due to the metal enhanced luminescence of SiO₂@Au. Among these SiO₂@Au samples, the luminescence intensity of the 2# SiO₂@Au-PtTFPP-based oxygen sensor, which is prepared with 60 ml HAuClO₄ growth solution, at 0.05% oxygen concentration is higher than that those with other SiO₂@Au samples; while the luminescence intensity of oxygen sensors with these SiO₂@Au samples is almost the same at 21% O₂. Below 9% oxygen concentrations, the luminescence intensity of the oxygen sensors with SiO₂@Au decreases in the order: 3# SiO₂@Au>1# SiO₂@Au>2# SiO₂@Au. The ratio of I_{O}/I_{21%} O₂ in SiO₂@Au-based oxygen sensors (FIG. 2B), increase in the same order (in this work, 10 is luminescence intensity at 0.05% O₂): 3# SiO₂@Au<1# SiO₂@Au<2# SiO₂@Au. The slope of Stem-Volmer plot based on the ratio of I_{O}/I_{[O2]} divided by the oxygen concentration is a measure of the relative sensitivity of the oxygen sensors. From 9%-21% O₂ concentrations, however, the slopes are almost the same, ranging from 3.6 for 1# SiO₂@Au to 3.8 for 2# SiO₂@Au. Compared with the slope of the Pt-based oxygen sensor, 0.56, this shows a 6.4 to 6.8-fold increase in sensitivity. When the oxygen concentration is below 9%, it can be dear seen that the Stern-Volmer plot of 2# SiO₂@Au is more linear than that of other SiO₂@Au samples, demonstrating the 2# SiO₂@Au—Pt-based oxygen sensor is more suitable in low oxygen concentration compared with other SiO₂@Au samples listed in the FIG. 6B. The maximum (I₀/I) for these curves range from 55-75, which compared with the maximum (I₀/I) of the Pt-based oxygen sensor, shows a 5-6.8 fold increase in the maximum attainable I₀I. The different sensitivity of these samples can be mainly attributed to the different luminescence intensity profiles of the PtTFPP-SiO₂(au-based oxygen sensors, that is to say, higher intensities at 0.05% O₂ (I_{O}) and almost the same intensities at 21% O₂ will led to higher sensitivities. The different enhancement of luminescence intensities is caused by the different absorbance peaks of different SiO₂@Au NPs, resulting in different overlap between excitation spectra of the dyes and LSPR of the SiO₂ Au NPs. The main absorbance of PtTFPP is localized at 392 nm and compared with the UV-Vis spectra of these SiO₂@Au samples, the 2# SiO₂@Au sample has the maximum overlap and thus the highest enhancement factor. These data provide further supportive experimental evidence that the luminescence intensity of dyes enhanced by the SiO₂@Au NPs strongly relies on the overlap between the LSPR of the NP with the excitation spectra properties of the dye.

Method for preparation of Ag@SiO₂ Nanospheres

In certain embodiments, the invention provides a noble metal nanoparticle coated with an electrical insulating material (i.e., a dielectric, such as silicon dioxide) to provide a nanostructure having plasmonic resonance properties (e.g., AgASiO₂ nanospheres). As used herein, the designation Ag@SiO₂ refers to nanostructure having a noble metal (i.e., silver) nanoparticle (e.g., core) coated with a pre-determined thickness of an electrical insulating material (silicon dioxide) coating or shell. The size of the noble metal nanoparticle and the thickness of the coating is controlled by the methods described herein to maximize an overlap of the plasmonic resonance of the noble metal nanoparticle (nanostructure) and the absorbance spectrum of an oxygen sensitive dye to enhance luminescence (e.g., phosphorescence) of the oxygen sensitive dye. These nanostructures can be used in oxygen sensitive compositions and for sensors and methods for determining oxygen concentration.

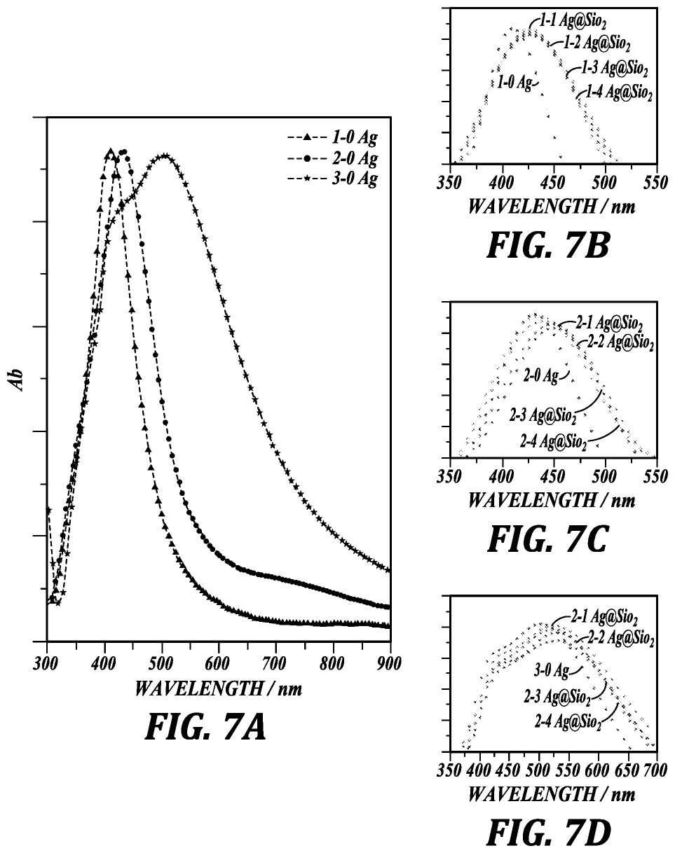

In a typical synthesis, a seeded growth method was employed to prepare monodisperse Ag nanospheres with different size range of 19-140 nm in a large quantity. As described herein, the seeded growth method was used to prepare three size Ag nanospheres (1-0: 40 nm; 2-0: 58 nm; 3-0: 95 nm). UV-vis spectroscopy of Ag quasi-nanospheres (FIG. 7A) in water was investigated to reveal their optical properties. It clearly demonstrates that the particle size plays a critical role in determining the optical properties of Ag nanospheres. As the size of Ag nanospheres increases, the absorbance peak shifts to longer wavelengths, which are centered at 410, 420, and 504 nm for Ag nanospheres of 35, 58, and 95 nm, respectively. When the particle size is above 95 nm, a shoulder appears at 419 nm, corresponding to a quadrupolar plasmon resonance, which becomes well resolved if the particle size becomes even larger. All of these spectra features are in good agreement with those simulated by the Mie theory. The Ag NPs obtained were then transferred to ethanol with the aid of 16-mercaptohexadecanoic acid (MHA) and then coated with a silica layer by a sol-gel reaction of tetraethyl orthosilicate (TEOS). Uniform silica coating over silver NPs was achieved by Stoker condensation reaction and the shell thickness was varied by controlling the amount of TEOS. As shown in the FIGS. 7B-7D, three sizes of Ag nanospheres coated with different amount of TEOS (20 ul; 50 ul; 100 ul; 160 ul) were prepared. The UV-vis spectra indicate that the plasmonic peaks of Ag@SiO₂ red shift and broader than that of bare Ag nanospheres. As the increase amount of TEOS, the plasmonic peaks of AgASiO₂ also red shifts and become broad, which are attributed to the thicker silica on the surface of Ag nanospheres.

Ag@SiO₂ Nanospheres and Oxygen Sensitive Luminescent Dyes

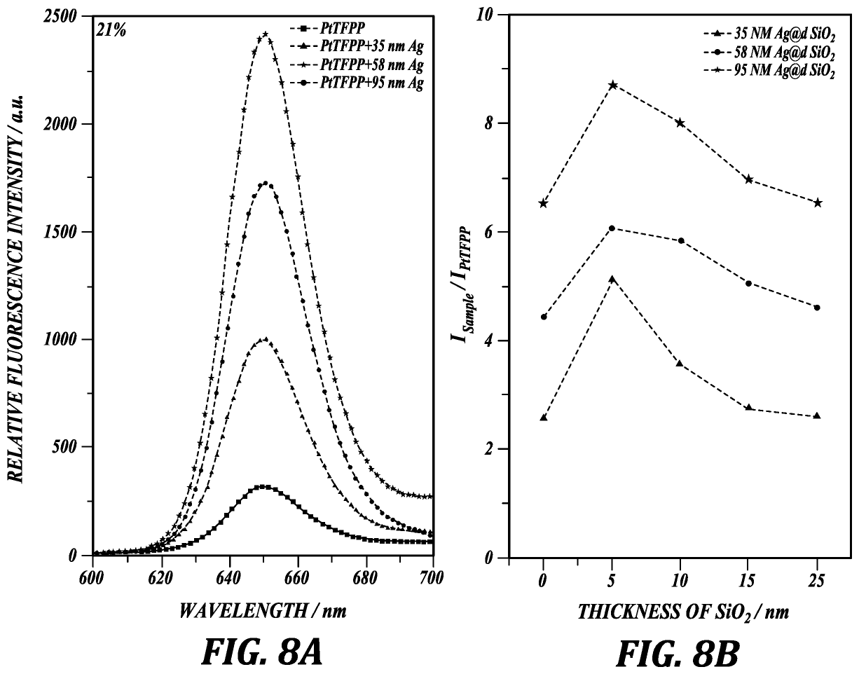

As shown in FIG. 8A, the luminescence intensity of Ag@SiO₂ nanospheres is highly dependent on the size of Ag nanospheres and the thickness of SiO₂. Each of the PtTFPP-based oxygen sensors with Ag nanospheres or Ag@SiO₂ nanospheres have a greater enhancement of luminescence than that of PtTFPP-based oxygen sensor at air pressure. FIG. 8B is a histogram of the luminescence intensity at the air pressure that shows the enhancement. Among the three sizes of Ag nanospheres we prepared, PtTFPP-based oxygen sensor with 95 nm Ag and 95 nm Ag@6 nm SiO₂ [this designation refers to an Ag nanoparticle with 95 nm diameter covered with SiO₂ having 6 nm thickness] have the highest luminescence emission intensity.

As used herein, the term “about” refers to ±5% of the specified value.

The following examples are provided for the purposes of illustrating, not limiting, the invention.

### EXAMPLES

### Example 1

### Synthesis of SiO₂ Nanospheres

In this example, the synthesis of representative SiO₂ nanospheres is described.

Colloidal silica nanospheres were prepared by a modified Stober method (W. Stober, A. Fink, E. Bohn, Journal of Colloid and Interface Science, 1968, 26, 62). In a typical synthesis for about 300 nm particles, 4.5 ml tetraethyl orthosilicate (TEOS) was mixed with 45.5 ml ethanol, and then added into a mixture solution containing 28 ml ethanol, 15 ml water and 7 ml aqueous solution of ammonia (28%). After stirring for 2 hours at room temperature, the silica particles were collected by centrifugation, washed with ethanol and water, and then re-dispersed in 20 ml water. As the TEM image shows in FIG. 2A, the silica nanoparticles are spherical with a diameter about 300 nm.

### Example 2

### Synthesis of SiO₂@Ag Nanospheres

In this example, the synthesis of representative SiO₂@Ag nanospheres described.

Disperse 0.6 g SiO₂ in 60 ml polyethyleneimine (PEI) (1% wt.) solution and stir for 4 h (see, e.g., J. Chen, J. Feng, Z. Li, P. Xu, X. Wang, W. Yin, M. Wang, X. Ge and Y. Yin, Nano Lett. 2019, 19, 400). Then the SiO₂ nanospheres were washed with water for three times and dissolved in 6 ml water (0.1 g/ml). After that 1 ml sample was pipetted to 5-120 ml THPC-Au seed solution under sonication for 1 h and stirring overnight. Then, the solution was centrifuged and dispersed in water. The TI-IPC-Au seed was synthesized using Balker's method (D. G. Duff, A. Bailer, P. P. Edwards, Langmuir, 1993, 9, 2301): A mixture of 1.35 ml NaOH (0.2 M), 41 ml water, 0.90 ml tetrakis(hydroxymethyl) phosphonium chloride (THPC) aqueous solution (1.2 mM) was prepared and stirred for 10 mins, to which 1.80 ml aqueous solution of chloroauric acid (25 mM) was added quickly. The final solution was aged at 4° C. for at least 2 weeks before use.

For the synthesis of SiO₂@Ag nanospheres, a solution of 10 ml H₂O, 10 ml trisodium citrate (0.1 M), 10 ml acetonitrile, 2 ml ascorbic acid (0.1 M) and 1 ml SiO₂@Au seed (30 mg/ml) was sonicated for 5 mins, then 0.25-2.00 ml AgNO (0.1 M) was added under sonication. for 10 mins. Finally, the sample was centrifuged and washed with water for 3 times (see, e.g., C. Gao, Q. Zhang, Z. Lu and Y. Yin, J Am. Chem. Soc., 2011, 133, 19706).

### Example 3

### Fabrication of SiO₂@Ag-based Pressure Sensor

In this example, the fabrication of a representative SiO₂@Ag nanosphere-based pressure sensor is described.

Octyl-triEOS (n-octyltriethoxysilane (octyl-triEOS))/TEOS composite sol-gel was selected as the matrix material in the PSP and prepared by mixing octyl-triEOS (0.20 ml) and TEOS (4.00 ml) to form a precursor solution according to the method described in C. S. Chu, T. W. Sung, Y. L. Lo, Sensors and Actuators B, 2013, 185, 287). Ethanol (1.25 ml) and HCl (0.1 M, 0.40 ml) were then added to the sol-gel solution to catalyze the reaction, The resulting solution was stirred magnetically for 111 at room temperature. Then 0.10 ml Triton-X-100 was added to improve the homogeneity of the silica sol. 20 mg SiO₂@Ag was added to 0.50 ml PtTFPP/EtOH (0.2 mg/ml) solution and stirred for 12 h. Then 0.50 ml composite sol-gel solution was added to the dye solution. Finally, the solution was capped and stirred magnetically for another 12 h. Before the PSP test, 200 ul sol-gel solution was dropped onto glass slide (2*2 cm²) and left to stabilize under ambient conditions for 24 h.

### Example 4

### Synthesis of SiO₂@Au Nanospheres

Synthesis of SiO₂@Au: the first step is loaded THPC-Au seeds onto SiO₂. It is same as described above in Example 3. The seed-mediated growth was then carried to deposit Au onto the Au seeds attached to the SiO₂ particles. A plating solution was firstly prepared by adding 7.5 ml of 25 mM HAuCl₄ in 500 ml of 1.8 mM K₂CO₃ aqueous solution and stored for a minimum of 24 h before use (K. Wang, Y. Wang, C. Wang, X. ha, J. Li, R. Xiao and S. Wang, BSC. Adv., 2018, 8, 30825-30831). The above SiO₂@Au seed solution was added to 20 ml of the plating solution, stirred for 5 min, and mixed with 0.2 ml of 100 mM trisodium citrate (TSC) and 0.05 ml of formaldehyde (37%), then stirred for 10 min. Finally, the sample was centrifuged and washed with water for 3 times. For the growth procedure, after centrifuging and washing, the prepared SiO₂ @Au samples were added to 20 ml plating solution and mixed with TSC and formaldehyde multiples times to prepare 1# SiO₂@Au (1 time), 2# SiO₂@Au (3 times), 3# SiO₂@Au (5 times).

### Example 5

### Synthesis of SiO₂@Au Nanospheres-based Pressure Sensor

The fabrication for this pressure sensor is the same as described for SiO₂@Ag nanospheres-based pressure sensor in Example 3.

### Example 6

### Synthesis of Ag@SiO₂ Nanospheres

Synthesis of Ag Quasi-nanospheres: Ag Quasi-nanospheres were prepared through a seeded growth method.

(1) Au seeds preparation: In a typical synthesis for about 3 nm Au seeds, 5 ml of PVP (polyvinylpyrrolidone) (5 wt % in H₂O), and 10 μl of HAuClO₄ (0.25 M) were dissolved in 5 ml H₂O (X. Liu, Y. Yin and C. Gao, Langmuir, 2013, 29, 10559-10565). After that, 0.6 ml of NaBH₄ (0.1 M) was injected under vigorous stirring. The as-prepared Au nanoparticles were then aged for 6 h, allowing complete decomposition of NaBH₄ before the subsequent seeded growth procedure.

(2) Ag Quasi-nanospheres: In a typical synthesis of 40 nm Ag quasi-nanospheres, 2 ml PVP (5 wt % in H₂O), 2 ml acetonitrile, and 100 μl ascorbic acid (0.1 M) were added in 2 ml 1420, which was thermostated at 10° C. Then, 150 μl AgNO₃ (0.1 M) was added, followed by quick injection of 10 μl seed solution. The Ag quasi-nanospheres were finally collected by centrifugation and repetitively washed with H₂O. To synthesize Ag quasi-nanospheres of other sizes, the reaction temperature was adjusted for favorable reaction kinetics, in addition to a change in the volume of the seed solution (C. Gao, Y. Hu, M. War;, M. Chi and Y. Yin, J. Am. Chem. Soc. 2014, 136, 7474-7479).

Synthesis of Ag@SiO₂: To the 5 ml Ag quasi-nanospheres solution was slowly added 4 ml 16-mercaptohexadecanoic acid (MHA) (1 mM), and the resultant solution was then mixed with 76 ml ethanol (C. Gao, Y. Hu, M. Wang, M. Chi and Y. Yin J. Am. Chem, Soc. 2014, 136; 7474-7479). After that, 4 ml Diethylamine and 20-160 μl tetraethyl orthosilicate (TEOS) were added in sequence under stirring and the reaction was allowed to proceed for 90 min. The volume of TEOS is varied for different thickness of SiO₂ (20 ul: 5 nm; 50 ul: 10 nm; 100 ul: 15 nm; 160 ul: 25 nm). This afforded a colloid of Ag@SiO₂ nanoparticles after centrifugation and dispersion in EtOH.

### Example 7

### Synthesis of Ag@SiO₂ Nanospheres-based Pressure Sensor

The fabrication for this pressure sensor is the same as described for SiO₂@Ag nanospheres-based pressure sensor in Example 3.

While illustrative embodiments have been illustrated and described, it will be appreciated that various changes can be made therein without departing from the spirit and scope of the invention.

1. A method for modulating the plasmonic resonance of a noble metal nanoparticle to enhance luminescence of an oxygen sensitive dye, comprising:
growing a pre-determined number of noble metal nanoparticles to a pre-determined size on a surface of a nanostructure to provide a nanostructure having a surface with a pre-determined density of noble metal nanoparticles of pre-determined size thereon,
wherein growing the noble metal nanoparticles comprises subjecting the surface with one or more noble metal particle forming reagents at a concentration and for a time sufficient to grow the nanoparticles to the pre-determined size, and
wherein the pre-determined density and the pre-determined size of the noble metal nanoparticles is adapted to maximize an overlap of the plasmonic resonance of the noble metal nanoparticles and the absorbance of an oxygen sensitive dye to enhance luminescence of the oxygen sensitive dye.

2. The method of claim 1, wherein the nanostructure is a nanosphere, a nanowire, a nanocluster, a nanorod, a nanocube, a nanostar, or a nanocage.

3. The method of claim 1, wherein growing the pre-determined number of noble metal nanoparticles on the surface comprises growing the noble metal nanoparticles from a pre-determined number of noble metal seeds deposited on the nanostructure surface.

4. (canceled)

5. The method of claim 1, wherein the nanostructure is a silicon dioxide nanosphere.

6. The method of claim 1, wherein the noble metal nanoparticle is a silver, gold, palladium, or platinum nanoparticle.

7. The method of claim 1, wherein the one or more noble metal particle forming reagents are noble metals salts suitable for reduction to provide noble metal nanoparticles.

8. (canceled)

9. The method of claim 1, wherein the plasmonic resonance of the noble metal nanoparticles is from about 400 to about 600 nm.

10. The method of claim 1, wherein the absorbance of the oxygen sensitive dye is in the range from about 400 to about 550 nm.

11. The method of claim 1, wherein the overlap between the plasmonic resonance of the noble metal nanoparticles and the absorbance of the oxygen sensitive dye is from about 390 to about 550 nm.

12. The method of claim 1, wherein the oxygen sensitive dye is a metalloporphyrin.

13. An oxygen sensor composition, comprising:
(a) a nanostructure having noble metal nanoparticles on its surface, the nanoparticles having a plasmonic resonance in the range from about 400 to about 600 nm;
(b) an oxygen sensitive dye having an emission sensitive to oxygen concentration, the oxygen sensitive dye having an absorbance in the range from about 390 to about 550 nm, wherein the plasmonic resonance of nanoparticles overlaps with the absorbance of the oxygen sensitive dye; and
(c) an oxygen permeable matrix in which the nanostructure and oxygen sensitive dye are dispersed.

14. The composition of claim 13, wherein the nanostructure is a nanosphere, a nanowire, a nanocluster, a nanorod, a nanocube, a nanostar, or a nanocage.

15. The composition of claim 13, wherein the nanostructure is a silicon dioxide nanosphere.

16. The composition of claim 13, wherein the noble metal nanoparticles are silver, gold, palladium, or platinum nanoparticles.

17. The composition of claim 13, wherein the oxygen sensitive dye is a metalloporphyrin.

18. The composition of claim 13, wherein oxygen permeable matrix is a sol-gel matrix.

19. A substrate having a surface on which the composition of claim 13 is deposited.

20. The substrate of claim 19, wherein the surface is a metal surface, a plastic surface, or a ceramic surface.

21. A method for determining oxygen concentration on a surface of a substrate, comprising:
(a) subjecting a substrate surface having the composition of claim 13 disposed thereon to an atmosphere that includes oxygen; and
(b) measuring the luminescent emission from the surface to determine oxygen concentration at the surface.

22. The method of claim 21, wherein subjecting the substrate surface to an atmosphere that includes oxygen comprises flowing the atmosphere over the surface.
